(19) United States
(12) Patent Application Publication
(10) Pub. No.: US 2009/0089124 A1
(43) Pub. Date: Apr. 2, 2009

(54) JOB PLACEMENT SYSTEM WITH PROFILE MATCHING

(75) Inventors: Shane A. Henderson, McKinney, TX (US); Robert Howard, Frisco, TX (US)

Correspondence Address: ANDERSON, LEVINE & LINTEL L.L.P., 14785 PRESTON ROAD, SUITE 650, DALLAS, TX, 75254, US

(73) Assignee: SIXFIRES, LLC, Dallas, TX (US)

(21) Appl. No.: 12/240,376

(22) Filed: Sep. 29, 2008

Related U.S. Application Data
(60) Provisional application No. 60/975,640, filed on Sep. 27, 2007.

(51) Int. Cl. G06Q 10/00; G06Q 20/00; G06F 17/30

(52) U.S. Cl. 705/7

(57) ABSTRACT

Potential employees are matched with employers by storing data in a computer database regarding information on job openings from multiple employers, information on employee candidates, and information about the employers. Candidates are scored relative to a specific job posting and an anonymous list of the highest scoring candidates with a graduated fee rate based on one or more factors relating to the specific job posting and the scores associated with the highest scoring candidates. A selected candidate is rewarded when the selected candidate's information is revealed to the employer.

### CROSS-REFERENCE TO RELATED APPLICATIONS

This applications claims the benefit of the filing date of copending provisional application U.S. Ser. No. 60/975,640 filed Sep. 27, 2007, entitled “JOB PLACEMENT SYSTEM WITH PROFILE MATCHING”, which is incorporated by reference herein.

### STATEMENT OF FEDERALLY SPONSORED RESEARCH OR DEVELOPMENT

Not Applicable

### BACKGROUND OF THE INVENTION

1. Technical Field

This invention relates in general to online job placement systems and, more particularly, to job placement systems with pre-screening.

2. Description of the Related Art

Using the Internet for job placement has become increasing popular. In 2007, a typical snapshot of the online job market would reveal about four million job advertisements spread over a large number of industries.

A typical job placement web site works as follows. Employers post information on available jobs for a fee. A single job posting may cost several hundred dollars, while buying multiple job postings in bulk may significantly reduce the price. The job posting includes several keywords that candidates can use for searches. Typical postings include the location, position (programmer, manager, nurse), part time/full time, job level, skills and/or education required, field (electronics, oil/gas, law, and so on), and one or more narratives describing the job and the company in greater detail. If a candidate finds a job listing that he or she qualifies for, the candidate can apply for the job on-line or through other methods.

Similarly, job placement web sites may allow job candidates to post their resumes along with desired employment information. Resume posting may be free or involve a small charge. Employers are charged for searching the resumes, typically using a time-based scale, with a maximum number of views. For example, a resume search of candidates within a 100 mile radius for one month (maximum 1500 resume views) may cost around $1000, while an annual subscription (maximum 20,000 views) may cost around $10,000. A keyword search will typically result in a report showing specific information about the matching candidates, with certain information withheld, such as name, current employer and contact information. From the basic information, the employer can choose which records to view.

While the use of the Internet provides access to a larger pool of jobs and candidates, the large number of candidates and jobs can be overwhelming to sort through. Some systems have been proposed for providing some level of intelligent matching between job postings and candidates, such as shown in U.S. Pub. No. 2001/0034630 to Mayer et al. In this system, keywords from candidate and job profiles are matched, and a list of matching candidate profiles with partial information (contact information excluded) is provided to the employer, who pays for each resume view. The list may be ordered according to the percentage of matching keywords. Systems of this nature suffer from two problems.

First, the vast majority of actual job placements are from candidates searching job listings, rather than through an employer's search of posted resumes. Primarily, the imbalance exists because many potential candidates would prefer to wait until a good job appears before taking the time to update their resume. A system that uses intelligent matching needs a large number of candidates to fulfill its goal; if the number of candidates is low, the system is simply finding the best candidate out of an insufficient pool.

Second, the results of the matching process will likely result in few or no “perfect” candidates, but quite a few good candidates. Since a system which matches candidates to jobs will charge more per resume view, and probably substantially more per view (since the matching process drastically reduces the number of views), qualified candidates with a less than perfect score might not get viewed. However, in actuality the reason for the lower score may have little to do with their qualifications for the job or their willingness to change jobs. Thus, systems of the type described in the Mayer patent application publication may eliminate qualified candidates for consideration.

Therefore, a need has arisen for an online job placement system with profile matching that encourages resume viewing and increases candidate participation.

### BRIEF SUMMARY OF THE INVENTION

In the present invention, a system for matching potential employees with employers comprises a computer database for storing (1) information on job postings from multiple employers, (2) information on employee candidates, and (3) information about the employers. A candidate/job matching and selection processor scores candidates relative to a specific job posting and generates an anonymous list of the highest scoring candidates with a graduated fee rate based on one or more factors relating to the specific job posting and the scores associated with the highest scoring candidates. A candidate payment system rewards a selected candidate when the selected candidate's information is revealed to the employer.

### BRIEF DESCRIPTION OF THE SEVERAL VIEWS OF THE DRAWINGS

For a more complete understanding of the present invention, and the advantages thereof, reference is now made to the following descriptions taken in conjunction with the accompanying drawings, in which:

FIG. 1 illustrates a block diagram of an online job placement system with graduated fee generation;

FIG. 2 illustrates a preferred embodiment for the candidate resume/personality entry process.

### DETAILED DESCRIPTION OF THE INVENTION

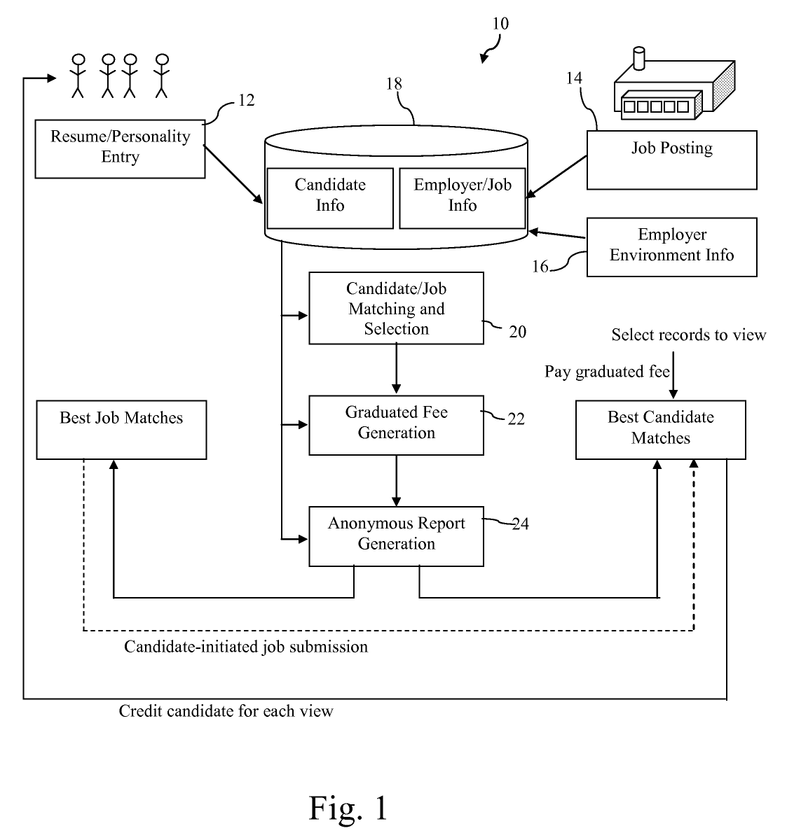

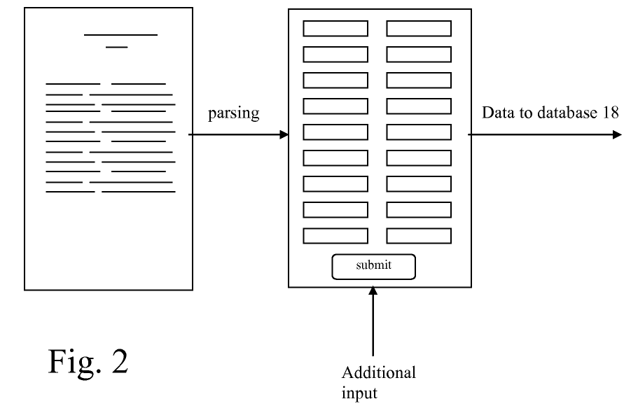

The present invention is best understood in relation to FIGS. 1-2 of the drawings, like numerals being used for like elements of the various drawings.

FIG. 1 illustrates a block diagram of an online job placement system with graduated fee generation. The online job placement system is denoted generally at reference numeral 10. The online job placement system 10 has several functions that operate continuously to find the best match between job candidates and job postings.

The resume/personality entry process 12 receives a resume and additional information from the candidate, or someone working on behalf of the candidate, regarding the qualifications, personal and professional traits, and job requirements for the candidate. It is assumed herein that information from the candidates (and the employers) is obtained using computers coupled to the Internet and/or other public or private global network, using a browser or proprietary software, although other solutions, including manual completion of forms, are possible. A more detailed description of the resume/personality entry process 12 is found below.

The job posting function 14 receives information regarding available jobs from the employer. A more detailed description of the job posting process 12 is found below.

The employment environment information function 16 receives information regarding the working environment at the employer. Some of the information, such as working hours, dress policy, benefits, vacation policy, may be available from the employer. Other information, however, such as work atmosphere, required overtime, and so on, which might not be specified accurately by the employer, can be generated using employee surveys.

The resume/personality entry 12, job posting 14 and employer environment information 16 processes format and feed the received information into a database 18.

A candidate/job matching and selection function 20 is performed on a computer with access to database 18 and uses the information in database 18 to score candidates relative to a job posting. Based on the score, a subset of the highest scoring candidates are selected for presentation to the employer posting the job. The number of selected candidates can vary based on employer preferences for the job posting: for example, a particular job posting may select the ten (or other predetermined number of) highest scores or all candidates scoring over a particular threshold. Criteria for scoring is described in greater detail below.

The graduated fee generation function 22 sets a fee for viewing the detailed candidate information for each of the selected candidates. Until the fee is paid, the employer can see only specific information that would allow the employer to make a decision whether or not to view the detailed information, but would not provide enough information for the employer to contact the candidate. The fee for a particular employee will vary depending upon the value of the candidate to the employer, where the value may be determined using a number of factors, including the salary for the position and the matching score determined by the candidate/job matching function 20. Other factors may be considered in setting the fee as well, such that a premium can be set for candidates in particularly sought-after fields or candidates with particular skill sets.

The information from the candidate/job matching and selection function 20 and graduated fee generation function 22 is used to generate an interactive report on the selected candidates. The report is sent to the employer who may select candidates for which the more information is desired.

The candidate/job matching and selection function 20, graduated fee generation function 22, and anonymous report generation function 24 can also be used to select the top job postings for a particular candidate. A candidate can then apply for a job with the employer. When initiated by a candidate, the employer receives an interactive report with the candidate's selected resume information, from which the employer can decide whether or not to pay the fee to see the detailed information including contact information. The fee depends upon the scoring and other factors described above.

In the preferred embodiment, candidates receive a fee (or other compensation) each time an employer selects to view their detailed resume information. The candidates could receive a set monetary award, a percentage of the fee, or a number of points based on the fee, where the points could be accumulated for an award, such as travel awards or products.

Once an employer pays to contact a candidate, the candidate is notified and given the opportunity to respond directly. The employer is provided with the job seeker's contact information and can contact them directly. The candidate is provided with additional information about the employer, such as job details, map directions, available interview slots, and so on.

The job placement system 10 described in FIG. 1 provides significant advantages over the prior art. First, candidates have an incentive to post and update their resumes, rather than simply search job openings, since they will receive compensation for their efforts. Further, candidates with experience in sought-after fields will have a greater incentive to look at other opportunities, since they will be compensated for posting their resumes relative to their value. Additionally, there is an incentive for candidates to share as much detail as possible when posting their profiles and to keep their resumes up to date, even when they are not actively pursuing a new job. Thus, the pool of candidates will increase and will be of higher quality.

Second, employees are presented with a list of quality candidates through intelligent matching and do not need to perform as much manual sifting of information to find acceptable candidates. Employers do not risk as much to view resumes of candidates with less than perfect qualifications, making it more likely that employers will look at more resumes.

FIG. 2 illustrates the resume/personality entry function. Using a computer coupled to the Internet or other network, a candidate enters information regarding, for example, his or her education, acquired skills, character traits, job requirements (title, industry, salary, and so on), acceptable locations, unacceptable locations, special needs (flexible hours, work at home), job history, certifications, seriousness about changing jobs, and so on. Some of this information may be parsed from an electronic copy of an existing resume, while other information can be entered into fields of a web page. When all mandatory fields have been completed and the submit button is pressed by the candidate, the information is sent to the database 18.

Job criteria for the job posting function 14 can be entered through a web page as well. Employers with multiple postings can automatically enter certain static information about the company from a template or previous posting. Information would include company demographic information, positions, salary, skill/education requirements, job responsibilities, travel responsibilities, experience level, benefits, hours, and so on.

Employer environment information can be entered in part by the employer, such as dress code and other restrictions, and other information can be gathered by email polling or other methods. Not every employer will need to enter environment information.

Database 18 may also contain other information derived from previous transactions, such as number of previous offers rejected, currently sought-after job types, etc.

The candidate/job matching and selection 20 function uses the information from database 18 to generate a score. Factors which could be used in computing the score could include: keyword matching with the resume information with the job posting information, personality of the job seeker with specified traits, number of years at previous company, employer distance from the job seeker's home (or specified desired locations), total years of relevant experience, total amount of management experience, number and length of gaps in employment, certifications held, relevant college degree(s), employment industry of job seeker, stated level of seriousness about switching jobs, quantity of employer contacts that the job seeker has obtained, the level of success from previous matches, and completeness of job seeker profile. Fraud checking may also factor into the score, based on the country of origin, IP address, etc. After scoring the candidates, a list is provided by the anonymous report generation function 24; however, the report generation function may be an ongoing process where additional candidates are sent to the employer until the job posting terminates at a given date or is removed by the employer.

The graduated fee function may base fees for a particular candidate largely on the score and the salary, but may take other factors into consideration. For example, programmers with a particular certification may be in high demand, and therefore worthy of a higher fee. This will encourage candidates in high-demand fields to post and update their resumes, because it will increase payments to the candidates for resume views.

While the present invention is described in connection with a job placement system, it should be noted that it would have applicability in other fields where recruiting is desired, such as club and society memberships and school admissions.

Although the Detailed Description of the invention has been directed to certain exemplary embodiments, various modifications of these embodiments, as well as alternative embodiments, will be suggested to those skilled in the art. The invention encompasses any modifications or alternative embodiments that fall within the scope of the Claims.

1. A system for matching potential employees with employers, comprising:
a computer database for storing:
information on job postings from multiple employers;
information on employee candidates;
information about the employers;
a candidate/job matching and selection processor for scoring candidates relative to a specific job posting and generating an anonymous list of the highest scoring candidates with a graduated fee rate based on one or more factors relating to the specific job posting and the scores associated with the highest scoring candidates; and
a candidate payment system for paying a selected candidate an award when the selected candidate's information is revealed to the employer.

2. The system of claim 1 wherein said one or more factors includes a salary associated with the specific job posting, wherein higher salaried job postings generate higher fees.

3. The system of claim 2 wherein the one or more factors include the field associated with the specific job posting, wherein more highly sought after fields generate higher fees.

4. The system of claim 1 wherein the employer associated with the specific job posting pays the fee associated with a candidate to receive a report about the candidate.

5. The system of claim 1 wherein the award is a portion of the fee.

6. A method for matching potential employees with employers, comprising:
storing in a computer database:
information on job openings from multiple employers;
information on employee candidates;
information about the employers;
scoring candidates relative to a specific job posting;
generating an anonymous list of the highest scoring candidates with a graduated fee rate based on one or more factors relating to the specific job posting and the scores associated with the highest scoring candidates; and
rewarding a selected candidate when the selected candidate's information is revealed to the employer.

7. The method of claim 6 wherein said one or more factors includes a salary associated with the specific job posting, wherein higher salaried job postings generate higher fees.

8. The method of claim 7 wherein the one or more factors include the field associated with the specific job posting, wherein more highly sought after fields generate higher fees.

9. The method of claim 6 and further comprising the step of receiving payment of the fee from the employer associated with the specific job posting upon providing a report about the selected candidate to the employer associated with the specific job posting.

10. The method of claim 6 wherein the award is a portion of the fee.
